(19) United States
(12) Patent Application Publication
(10) Pub. No.: US 2014/0073599 A1
(43) Pub. Date: Mar. 13, 2014

(54) Plant Treatment Compositions and Methods for Their Use

(71) Applicants: Tak Wai Cheung, Yuma, AZ (US); Kenneth Roger Muzyk, Brandon, FL (US); John Edward Frieden, Kansas City, MO (US); Jaheo Cha, St. Paul, MN (US); Olaf Moberg, New Brighton, MN (US); Susan Oeltjen, Lake Elmo, MN (US); Christopher Rueb, St. Paul, MN (US); Willie Hendrickson, Woodbury, MN (US)

(72) Inventors: Tak Wai Cheung, Yuma, AZ (US); Kenneth Roger Muzyk, Brandon, FL (US); John Edward Frieden, Kansas City, MO (US); Jaheo Cha, St. Paul, MN (US); Olaf Moberg, New Brighton, MN (US); Susan Oeltjen, Lake Elmo, MN (US); Christopher Rueb, St. Paul, MN (US); Willie Hendrickson, Woodbury, MN (US)

(21) Appl. No.: 12/918,156

(22) PCT Filed: Mar. 9, 2009
(86) PCT No.: PCT/US09/01499

§ 371 Date: Apr. 18, 2011

Related U.S. Application Data
(60) Provisional application No. 61/035,627, filed on Mar. 11, 2008.
(60) Provisional application No. 61/037,876, filed on Mar. 19, 2008.

(51) Int. Cl. A01N 55/02

(52) U.S. Cl. CPC A01N 55/02
USPC 514/54; 536/3

(57) ABSTRACT

Plant treatment compositions comprising metal alginate salts as compositions useful in the treatment of plants, particularly food crops. The metal alginate salts are found to be effective in the absence of herbicides, fungicides and pesticides.

The present invention relates to plant treatment compositions and methods for their use. More particularly the present invention relates to plant treatment compositions comprising metal alginate salts as compositions useful in the treatment of plants, particularly food crops, methods for the production of such plant treatment compositions, and methods for their use.

The control of pathogentic fungi and bacteria and other diseases is of great economic importance since fungal growth on plants or on parts of plants inhibits production of foliage, fruit or seed, and the overall quality of a cultivated crop.

U.S. Pat. No. 5,977,023 discloses pesticidal compositions which necessarily include both a pesticide, and further necessarily include a pest-controlling active ingredient and/or a plant growth regulating active ingredient with a water insoluble alginate salt. The resultant compositions are granulated or pulvurent compositions which necessarily include both a pest-controlling active ingredient and/or a plant growth regulating active ingredient with the water insoluble alginate salt. The compositions of U.S. Pat. No. 5,977,023 are prepared by treating a solid composition containing a pest-controlling active ingredient or a plant growth-regulating active ingredient and an alginic acid or a water-soluble alginate with an aqueous solution containing a divalent or polyvalent cation which can convert the alginic acid or water-soluble alginate into a water-insoluble alginate. Otherwise, the composition of the invention is prepared by coating a solid substance containing a pesticidally active ingredient which is a pest-controlling active ingredient or a plant growth-regulating active ingredient with a water-insoluble alginate. The function of the water-insoluble alginates are cited to impart controlled release, as well as sustained release properties of the pest-controlling active ingredient and/or a plant growth regulating active ingredient.

Although the prior art provides a wide variety of chemical compounds and chemical preparations or compositions which are useful as plant treatment compositions for the control of pathogentic fungi and bacteria and other diseases in plants and particularly plant crops, there nonetheless remains a real and urgent need for improved plant treatment compositions which provide such benefits. Likewise there remains a continuing need for improved methods for providing preventive and curative fungicidal activity for the protection of cultivated plants with a minimum of undesired side effects, and with relative safety for animals and humans.

It is to these and other objects that present invention is directed.

In a first aspect there are provided plant treatment compositions comprising metal alginate salts as compositions useful in the treatment of plants, particularly food crops.

In a second aspect there are provided methods for the production of plant treatment compositions comprising metal alginate salts as compositions useful in the treatment of plants, particularly food crops.

A third aspect of the invention relates to methods for the treatment of plants, including food crops in order to control the incidence of and/or spread of pathogentic fungi and bacteria and other diseases in said plants and particularly food crops and providing improved plant health and/or food crop yields.

In a yet further aspect of the invention there are provided plant treatment compositions which are particularly useful in the treatment of tomato plants and for controlling the incidence and spread of undesired bacterial pathogens, e.g., bacterial spot, such as may be caused by genus Xanthomonas, e.g, Xanthomonas campestris pv. vesicatoria; bacterial speck, such as may be caused by genus Pseudomonas e.g., Pseudomonas syringae PV tomato; and citrus canker, such as may be caused by genus Xanthomonas e.g., Xanthomonas axonopodis pv. citri These and other aspects of the invention will be better understood from the following specification.

The present inventors have discovered that plant treatment compositions comprising metal alginate salt compositions useful in the treatment of plants, particularly food crops. Such metal alginate salt compositions are effective when provided in the absence of other biologically active materials, e.g., materials which exhibit or provide pesticidal, disease control, including fungicidal, mildew control or herbicidal or plant growth regulating effects. However the plant treatment compositions comprising metal alginate salt compositions are expected to be useful when provided in conjunction with one or more of aforesaid biologically active materials. Plant treatment compositions of the invention may also include one or more non-biologically active materials which are recognized as being useful in the art.

The plant treatment compositions of the invention necessarily include one or more metal alginate salts. The one or more metal alginate salts may be compounds or complexes comprising the at least one metal selected from the transition elements represented on Groups 2-12, as well as any of the metals of Groups 13-15 of the Periodic Table of Elements. Particularly preferred are one or more metals selected from magnesium, iron, copper, nickel, zinc, aluminum, palladium, cadmium, platinum, lead, and gold, but preferably the metal alginate salts are based on nickel, copper, zinc, aluminum, palladium, silver, or tin, and especially are based on copper alginate salts. Copper alginate salts are found to be economically feasible, and have been proven to be effective as is disclosed in one or more of the examples illustrated below. Further useful alginate salts are discussed following. However, the use of other metals or metallic cations although not expressly demonstrated in one or more the following examples is nonetheless is contemplated to be within the scope of the present invention.

The metal alginate salts of the invention may be formed by any conventional means which is currently known to the art, such as by combining metal cations with one or more water-soluble alginates, e.g. alkali metal salts of alginic acid such as sodium alginate and potassium alginate, as well as ammonium salts of alginic acid, in order to form water-insoluble metal alginate salts. Non-limiting examples of divalent or polyvalent cations which can convert an alginic acid or a water-soluble alginate into a water-insoluble alginate are calcium cations, magnesium cations, barium cations, zinc cations, nickel cations, copper cations, silver cations and lead cations. Examples of particular aqueous solutions containing the cation include ones which contain calcium salts such as aqueous solutions of calcium chloride, calcium nitrate, calcium lactate, and calcium citrate, those containing magnesium salts such as aqueous solutions of magnesium chloride, those containing barium salts such as aqueous solutions of barium chloride, those containing zinc salts such as aqueous solutions of zinc chloride, zinc nitrate, and zinc sulfate, those containing nickel salts such as aqueous solutions of nickel chloride, those containing copper salts such as aqueous solutions of copper sulfate, and those containing lead salts such as aqueous solutions of lead acetate. In such solutions, the content of the cation salt may be of any effective amount but advantageously is usually 1% by weight through saturated concentration, preferably 5% by weight through saturated concentration in aqueous solution. Although low-molecular through high-molecular weight water-soluble alginates and alginic acids can be used in the compositions of the present invention, the molecular weight of the alginic acid or water-soluble alginate is typically 500 through 10,000,000, preferably 1,000 through 5,000,000 and most preferably 3,000 through 2,000,000. The alginic acid or water-soluble alginate may be used in admixture of those having different molecular weights. Furthermore mixtures of two or more metal alginate salts may also be used.

The amounts of metal alginate salts in the plant treatment compositions of the invention may vary widely and in part, depend upon the form of the product of the plant treatment compositions. Generally speaking the metal alginate salts may be provided in amounts of as little as 0.0001% wt. to 100% wt. of the plant treatment composition of which it forms a part. For example, higher concentrations are to be expected wherein the form of the plant treatment composition is a concentrate or super-concentrate composition which is provided to a consumer with instructions to form a dilution in a liquid or solid carrier, e.g., water or other solvent, prior to application to plants. Lesser concentrations are expected wherein the plant treatment composition is provided as a ready-to-use product which is intended to be dispensed directly without further dilution from any container onto a plant. The composition may be applied “neat” in water, or as part of a “tank mix” with other materials or constituents.

Advantageously, the final end-use concentration of the one or more metal alginate salts in the plant treatment compositions, viz., the concentration of the one or more metal alginate salts in the plant treatment compositions which are in the form as applied to seeds, plants or for that matter soil, are those which are found to be affected in the treatment of a particular plant or crop, which is understood to be variable. Advantageously the concentration of the one or more metal alginate salts in such end-use plant treatment compositions can be as little as 0.01 ppm, and 100,000 ppm, preferably between 0.01 ppm and 10,000 ppm. Surprisingly the inventors have found that the metal alginate salts of the plant treatment compositions in such final end-use concentrations are effective in amounts which are typically less, and frequently far less than the amounts of the active amounts of conventional pest-controlling active ingredient and/or a plant growth-regulating active ingredient, viz., herbicidal, fungicidal or pesticidal compounds which are necessary in order to provide a comparable benefit level. The inventors have also discovered that the use of the metal alginate salts permits for the application at lower rates than certain commercial products (KOCIDE), as it is believed that the applied coverage of the product permits for a more uniform, and more complete application permit for the improved deposition and retention of the compositions on plant surfaces.

The inventors have also surprisingly discovered that the metal alginate salts, particularly those based on copper salts show surprisingly good efficacy against certain copper resistant strains or pathogens on plants, which has not been effectively treated by prior art commercially available preparations, e.g. KOCIDE (ex. E.I. DuPont de Nemours). It is expected that such salts based on or including other metals, especially silver, are also expected to provide good results.

Contrary to U.S. Pat. No. 5,977,023, the present inventors have discovered that their compositions can provide an effective treatment composition for control of pathogentic fungi and bacteria and other diseases in plants and particularly plant crops even in the absence of a pest-controlling active ingredient and/or a plant growth-regulating active ingredient. In certain preferred embodiments of the plant treatment compositions of the invention, such pest-controlling active ingredient or a plant growth-regulating active ingredients are absent and are excluded from the plant treatment compositions of the invention.

While not wishing to be bound by the following hypothesis, it is believed that the metallic salt alginates have a degree of surface “tackiness” when a formulation containing the same is applied from an aqueous solution to plant surfaces, and that at least the metallic salt alginate adhere to the plant foliage, fruit or crop to which it has been applied. This tackiness increases the amount of metallic salt alginates which adhere to the plant matter surfaces and also retains the metallic salt alginates on the plant surfaces which is believed to enhance their durability and retention on plant surfaces, and thereby provide a longer lasting benefit. While the mechanism is not clearly understood, it has nonetheless surprisingly been observed that the metal alginate salts appear to provide a beneficial effect even in the absence of conventional pesticides, fungicides, or herbicides particularly as is demonstrated in one or more of the following examples. It is hypothesized that the metal contributes to the beneficial effect.

The plant treatment compositions of invention may optionally include one or more constituents or materials especially other biologically active materials, e.g., materials which exhibit or provide pesticidal, disease control, including fungicidal, mildew control or herbicidal or plant growth regulating effects, as well as one or more non-biologically active materials.

By way of nonlimiting examples, examples of biologically active materials include materials which exhibit or provide pesticidal, disease control, including fungicidal, mildew control or herbicidal or plant growth regulating effects.

Exemplary fungicides which may be used in the plant treatment compositions of the invention include one or more of: 2-phenylphenol; 8-hydroxyquinoline sulfate; AC 382042; Ampelomyces quisqualis; Azaconazole; Azoxystrobin; Bacillus subtilis; Benalaxyl; Benomyl; Biphenyl; Bitertanol; Blasticidin-S; Bordeaux mixture; Borax; Bromuconazole; Bupirimate; Calboxin; calcium polysulfide; Captafol; Captan; Carbendazim; Carpropanmid (KTU 3616); CGA 279202; Chinomethionat; Chlorothalonil; Chlozolinate; copper hydroxide; copper naphthenate; copper oxychloride; copper sulfate; cuprous oxide; Cymoxanil; Cyproconazole; Cyprodinil; Dazomet; Debacarb; Dichlofluanid; Dichlomezine; Dichlorophen; Diclocymet; Dicloran; Diethofencarb; Difenoconazole; Difenzoquat; Difenzoquat metilsulfate; Diflumetorim; Dimethirimol; Dimethomorph; Diniconazole; Diniconazole-M; Dinobuton; Dinocap; diphnenylamine; Dithianon; Dodemorph; Dodemorph acetate; Dodine; Dodine free base; Edifenphos; Epoxiconazole (BAS 480F); Ethasulfocarb; Ethirimol; Etridiazole; Famoxadone; Fenamidone; Fenarimol; Fenbuconazole; Fenfin; Fenfuram; Fenhexamid; Fenpiclonil; Fenpropidin; Fenpropimorph; Fentin acetate; Fentin hydroxide; Ferbam; Ferimzone; Fluazinam; Fludioxonil; Fluoroimide; Fluquinconazole; Flusilazole; Flusulfamide; Flutolanil; Flutriafol; Folpet; formaldehyde; Fosetyl; Fosetyl-aluminum; Fuberidazole; Furalaxyl; Fusarium oxysporum; Gliocladium virens; Guazatine; Guazatine acetates; GY-81; hexachlorobenzene; Hexaconazole; Hymexazol; ICIA0858; IKF-916; Imazalil; Imazalil sulfate; Imibenconazole; Iminoctadine; Iminoctadine triacetate; Iminoctadine tris[Albesilate]; Ipconazole; Iprobenfos; Iprodione; Iprovalicarb; Kasugamycin; Kasugamycin hydrochloride hydrate; Kresoxim-methyl; Mancopper; Mancozeb; Maneb; Mepanipyrim; Mepronil; mercuric chloride; mercuric oxide; mercurous chloride; Metalaxyl; Metalaxyl-M; Metam; Metam-sodium; Metconazole; Methasulfocarb; methyl isothiocyanate; Metiram; Metominostrobin (SSF-126); MON65500; Myclotbutanil; Nabam; naphthenic acid; Natamycin; nickel bis(dimethyldithiocarbamate); Nitrothal-isopropyl; Nuarimol; Octhilinone; Ofurace; oleic acid (fatty acids); Oxadixyl; Oxine-copper; Oxycarboxin; Penconazole; Pencycuron; Pentachlorophenol; pentachlorophenyl laurate; Perfurazoate; phenylmercury acetate; Phlebiopsis gigantea; Phthalide; Piperalin; polyoxin B; polyoxins; Polyoxorim; potassium hydroxyquinoline sulfate; Probenazole; Prochloraz; Procymidone; Propamocarb; Propamocarb Hydrochloride; Propiconazole; Propineb; Pyrazophos; Pyributicarb; Pyrifenox; Pyrimethanil; Pyroquilon; Quinoxyfen; Quintozene; RH-7281; sec-butylamine; sodium 2-phenylphenoxide; sodium pentachlorophenoxide; Spiroxamine (KWG 4168); Streptomyces griseoviridis; sulfur; tar oils; Tebuconazole; Tecnazene; Tetraconazole; Thiabendazole; Thifluzamide; Thiophanate-methyl; Thiram; Tolclofos-methyl; Tolylfluanid; Triadimefon; Triadimenol; Triazoxide; Trichoderma harzianum; Tricyclazole; Tridemorph; Triflumizole; Triforine; Triticonzole; Validamycin; vinclozolin; zinc naphthenate; Zineb; Ziram; the compounds having the chemical name methyl (E,E)-2-(2-(1-(1-(2-pyridyl)propyloxyimino)-1-cyclopropylmethyloxymethyl)phenyl)-3-ethoxypropenoate and 3-(3,5-dichlorophenyl)-4-chloropyrazole.

When present the one or more fungicides, may be included in any effective amount, and advantageously are present in amounts of from 5 ppm to 50,000 ppm, preferably 10 ppm to 10,000 ppm based on total weight of the plant treatment composition of which it forms a part, as applied to the plant.

Exemplary pesticides include insecticides, acaricides and nematocides, which be used singly or in mixtures in the plant treatment compositions of the invention. By way of non-limiting example such include one or more of: Abamectin; Acephate; Acetamiprid; oleic acid; Acrinathrin; Aldicarb; Alanycarb; Allethrin [(1R) isomers]; .alpha.-Cypermethrin; Amitraz; Avermectin B1 and its derivatives, Azadirachtin; Azamethiphos; Azinphos-ethyl; Azinphosmethyl; Bacillus thurigiensi; Bendiocarb; Benfuracarb; Bensultap; .beta.-cyfluthrin; .beta.-cypermethrin; Bifenazate; Bifenthrin; Bioallathrin; Bioallethrin (S-cyclopentenyl isomer); Bioresmethrin; Borax; Buprofezin; Butocarboxim; Butoxycarboxim; piperonyl butoxide; Cadusafos; Carbaryl; Carbofuran; Carbosulfan; Cartap; Cartap hydrochloride; Chordane; Chlorethoxyfos; Chlorfenapyr; Chlorfenvirnphos; Chlorfluazuron; Chlormephos; Chloropicrin; Chlorpyrifos; Chlorpyrifos-methyl; mercurous chloride; Coumaphos; Cryolite; Cryomazine; Cyanophos; calcium cyanide; sodium cyanide; Cycloprothrin; Cyfluthrin; Cyhalothrin; cypermethrin; cyphenothrin [(1R) transisomers]; Dazomet; DDT; Deltamethrin; Demeton-S-methyl; Diafenthiuron; Diazinon; ethylene dibromide; ethylene dichloride; Dichlorvos; Dicofol; Dicrotophos; Diflubenzuron; Dimethoate; Dimethylvinphos; Diofenolan; Disulfoton; DNOC; DPX-JW062 and DP; Empenthrin [(EZ)-(1R) isomers]; Endosulfan; ENT 8184; EPN; Esfenvalerate; Ethiofencarb; Ethion; Ethiprole having the chemical name 5-amino-3-cyano-1-(2,6-dichloro-4-trifluoromethylphenyl)-4-ethylsulfinylpy razole; Ethoprophos; Etofenprox; Etoxazole; Etrimfos; Famphur; Fenamiphos; Fenitrothion; Fenobucarb; Fenoxycarb; Fenpropathrin; Fenthion; Fenvalerate; Fipronil and the compounds of the arylpyrazole family; Flucycloxuron; Flucythrinate; Flufenoxuron; Flufenprox; Flumethrin; Fluofenprox; sodium fluoride; sulfuryl fluoride; Fonofos; Formetanate; Formetanate hydrochloride; Formothion; Furathiocarb; Gamma-HCH; GY-81; Halofenozide; Heptachlor; Heptenophos; Hexaflumuron; sodium hexafluorosilicate; tar oils; petroleum oils; Hydramethylnon; hydrogen cyanide; Hydroprene; Imidacloprid; Imiprothrin; Indoxacarb; Isazofos; Isofenphos; Isoprocarb; Methyl isothiocyanal; Isoxathion; lambda-Cyhalothrin; pentachlorophenyl laurate; Lufenuron; Malathion; MB-599; Mecarbam; Methacrifos; Methamidophos; Methidathion; Methiocarb; Methomyl; Methoprene; Methoxychlor; Metolcarb; Mevinphos; Milbemectin and its derivatives; Monocrotophos; Naled; nicotine; Nitenpyram; Nithiazine; Novaluron; Omethoate; Oxamyl; Oxydemeton-methyl; Paecilomyces fumosoroseus; Parathion; Parathion-methyl; pentachlorophenol; sodium pentachlorophenoxide; Permethrin; Penothrin [(1R)-trans-isomers]; Phenthoate; Phorate; Phosalone; Phosmet; Phosphamidon; phosphine; aluminum phosphide; magnesium phosphide; zinc phosphide; Phoxim; Pirimicarb; Pirimiphos-ethyl; Pirimiphos-methyl; calcium polysulfide; Prallethrin; Profenfos; Propaphos; Propetamphos; Propoxur; Prothiofos; Pyraclofos; pyrethrins (chrysanthemates, pyrethrates, pyrethrum; Pyretrozine; Pyridaben; Pyridaphenthion; Pyrimidifen; Pyriproxyfen; Quinalphos; Resmethrin; RH-2485; Rotenone; RU 15525; Silafluofen; Sulcofuron-sodium; Sulfotep; sulfuramide; Sulprofos; Ta-fluvalinate; Tebufenozide; Tebupirimfos; Teflubenzuron; Tefluthrin; Temephos; Terbufos; Tetrachlorvinphos; Tetramethrin; Tetramethrin [(1R) isomers]; .theta.-cypermethrin; Thiametoxam; Thiocyclam; Thiocyclam hydrogen oxalate; Thiodicarb; Thiofanox; Thiometon; Tralomethrin; Transfluthrin; Triazamate; Triazophos; Trichlorfon; Triflumuron; Trimethacarb; Vamidothion; XDE-105; XMC; Xylylcarb; Zeta-cypermethrin; ZXI 8901; the compound whose chemical name is 3-acetyl-5-amino-1-[2,6-dichloro-4-(trifluoromethyl)phenyl]-2-methylsulfinylpyrazole.

When present the one or more pesticides, may be included in any effective amount, and advantageously are present in amounts of from 5 ppm to 50,000 ppm, preferably 10 ppm to 10,000 ppm based on total weight of the plant treatment composition of which it forms a part, particularly in final end-use concentrations of the plant treatment compositions as applied to the plant.

Exemplary herbicides which may be used in the plant treatment compositions of the invention, may include one or more of: 2,3,6-TBA; 2,4-D; 2,4-D-2-ethylhexyl; 2,4-DB; 2,4-DB-butyl; 2,4-DB-dimethylammonium; 2,4-DB-isooctyl; 2,4-DB-potassium; 2,4-DB-sodium; 2,4-D-butotyl (2,4-D-Butotyl (2,4-D Butoxyethyl Ester)); 2,4-D-butyl; 2,4-D-dimethylammonium; 2,4-D-Diolamine; 2,4-D-isoctyl; 2,4-D-isopropyl; 2,4-D-sodium; 2,4-D-trolamine; Acetochlor; Acifluorfen; Acifluorfen-sodium; Aclonifen; Acrolein; AKH-7088; Alachlor; Alloxydim; Alloxydim-sodium; Ametryn; Amidosulfuron; Amitrole; ammonium sulfamate; Anilofos; Asulam; Asulam-sodium; Atrazine; Azafenidin; Azimsulfuron; Benazolin; Benazolin-ethyl; Benfluralin; Benfuresate; Benoxacor; Bensulfuron; Bensulfuron-methyl; Bensulide; Bentazone; Bentazone-sodium; Benofenap; Bifenox; Bilanofos; Bilanafos-sodium; Bispyribac-sodium; Borax; Bromacil; Bromobutide; Bromofenoxim; Bromoxynil; Bromoxynil-heptanoate; Bromoxynil-octanoate; Bromoxynil-potassium, Butachlor; Butamifos; Butralin; Butroxydim; butylate; Cafenstrole; Carbetamide; Carfentrazone-ethyl; Chlomethoxyfen; Chloramben; Chlorbromuron; Chloridazon; Chlorimuron; Chlorimuron-ethyl; Chloroacetic Acid; Chlorotoluron; Chlorpropham; Chlorsulfuron; Chlorthal; Chlorthal-dimethyl; Chlorthiamid; Cinmethylin; Cinosulfuron; Clethodim; Clodinafop; Clodinafop-Propargyl; Clomazone; Clomeprop; Clopyralid; Clopyralid-Olamine; Cloquintocet; Cloquintocet-Mexyl; Chloransulam-methyl; CPA; CPA-dimethylammonium; CPA-isoctyl; CPA-thioethyl; Cyanamide; Cyanazine; Cycloate; Cyclosulfamuron; Cycloxydim; Cyhalofop-butyl; Daimuron; Dalapon; Dalapon-sodium; Dazomet; Desmeduipham; Desmetryn; Dicamba; Dicamba-dimethylammonium; Dicamba-potassium; Dicamba-sodium; Dicamba-trolamine; Dichlobenil; Dichlormid; Dichlorprop; Dichlorprop-butotyl (Dichlorprop-butotyl (Dichlorpropbutoxyethyl ester)); Dichlorprop-dimethylammonium; Dichlorprop-isoctyl; Dichlorprop-P; Dichlorprop-potassium; Diclofop; Diclofop-methyl; Difenzoquat; Difenzoquat metilsulfate; Diflufenican; Diflufenzopyr (BAS 654 00 H); Dimefuron; Dimepiperate; Dimethachlor; Dimethametryn; Dimethenamid; Dimethipin; dimethylarsinic acid; Dinitramine; Dinoterb; Dinoterb acetate; Dinoterb-ammonium; Dinoterb-diolamine; Diphenamid; Diquat; Diquat dibromide; Dithiopyr; Diuron; DNOC; DSMA; Endothal; EPTC; Esprocarb; Ethalfluralin; Ethametsulfuron-methyl; Ethofumesate; Ethoxysulfuron; Etobenzanid; Fenchlorazole-ethyl; Fenclorim; Fenoxaprop-P; Fenoxaprop-P-ethyl; Fenuron; Fenuron-TCA; Ferrous Sulfate; Flamprop-M; Flamprop-M-Isopropyl; Flamprop-M-methyl; Flazasulfuron; Fluazifop; Fluazifop-butyl; Fluazifop-P; Fluazifop-P-butyl; Fluazolate; Fluchloralin; Flufenacet (BAS FOE 5043); Flumetsulam; Flumiclorac; Flumiclorac-Pentyl; Flumioxazin; Fluometuron; Fluoroglycofen; Fluoroglycofen-ethyl; Flupaxam; Flupoxam; Flupropanate; Flupropanate-sodium; Flupyrsulfuron-methyl-sodium; Flurazole; Flurenol; Flurenol-butyl; Fluridone; Fluorochloridone; Fluoroxypyr; Fluoroxypyr-2-Butoxy-1-methylethyl; Fluoroxypyr-methyl; Flurtamone; Fluthioacet-methyl; Fluxofenim; Fomesafen; Fomesafen-sodium; Fosamine; Fosamine-ammonium; Furilazole; Glyphosate; Glufosinate; Glufosinate-ammonium; Glyphosate-ammonium; Glyphosate-isopropylammonium; Glyphosate-sodium; Glyphosate-trimesium; Halosulfuron; Halosulfuron-methyl; Haloxyfop; Haloxyfop-P-methyl; Haloxyfop-etotyl; Haloxyfop-methyl; Hexazinone; Hilanafos; Imazacluin; Imazamethabenz; Imazamox; Imazapyr; Imazapyr-isopropylammonium; Imazaquin; Imazaquin-ammonium; Imazemethabenz-methyl; Imazethapyr; Imazethapyr-ammonium; Imazosulfuron; Imizapic (AC 263,222); Indanofan; Ioxynil; Ioxynil octanoate; Ioxynil-sodium; Isoproturon; Isouron; Isoxaben; Isoxaflutole; Lactofen; Laxynel octanoate; Laxynil-sodium; Lenacil; Linuron; MCPA; MCPA-butotyl; MCPA-dimethylammonium; MCPA-isoctyl; MCPA-potassium; MCPA-sodium; MCPA-thioethyl; MCPB; MCPB-ethyl; MCPB-sodium; Mecoprop; Mecoprop-P; Mefenacet; Mefenpyr-diethyl; Mefluidide; Mesulfuron-methyl; Metam; Metamitron; Metam-sodium; Metezachlor; Methabenzthiazuron; methyl isothiocyanate; methylarsonic acid; Methyldymron; Metobenzuron; Metobromuron; Metolachlor; Metosulam; Metoxuron; Metribuzin; Metsulfuron; Molinate; Monolinuron; MPB-sodium; MSMA; Napropamide; Naptalam; Naptalam-sodium; Neburon; Nicosulfuron; nonanoic acid; Norflurazon; oleic acid (fatty acids); Orbencarb; Oryzalin; Oxabetrinil; Oxadiargyl; Oxasulfuron; Oxodiazon; Oxyfluorfen; Paraquat; Paraquat Dichloride; Pebulate; Pendimethalin; Pentachlorophenol; Pentachlorophenyl Laurate; Pentanochlor; Pentoxazone; petroleum oils; Phenmedipham; Picloram; Picloram-potassium; Piperophos; Pretilachlor; Primisulfuron; Primisulfuron-methyl; Prodiamine; Prometon; Prometryn; Propachlor; Propanil; Propaquizafop; Propazine; Propham; Propisochlor; Propyzamide; Prosulfocarb; Prosulfuron; Pyraflufen-ethyl; Pyrazasulfuron; Pyrazolynate; Pyrazosulfuron-ethyl; Pyrazoxyfen; Pyribenzoxim; Pyributicarb; Pyridate; Pyriminobac-methyl; Pyrithiobac-sodium; Quinclorac; Quinmerac; Quinofolamine; Quizalofop; Quizalofop-ethyl; Quizalofop-P; Quizalofop-P-ethyl; Quizalofop-P-Tefuryl; Rimsulfuron; Sethoxydim; Siduron; Simazine; Simetryn; sodium chlorate; sodium chloroacetate; sodium pentachlorophenoxide; sodium-Dimethylarsinate; Sulcotrione; Sulfentrazone; Sulfometuron; Sulfometuron-methyl; Sulfosulfuron; Sulfuric acid; tars; TCA-sodium; Tebutam; Tebuthiuron; Tepraluxydim (BAS 620H); Terbacil; Terbumeton; Terbuthylazine; Terbutryn; Thenylchlor; Thiazopyr; Thifensulfuron; Thifensulfuron-methyl; Thiobencarb; Tiocarbazil; Tralkoxydim; triallate; Triasulfuron; Triaziflam; Tribenuron; Tribenuron-methyl; Tribenuron-methyl; trichloroacetic acid; Triclopyr; Triclopyr-butotyl; Triclopyr-triethylammonium; Trietazine; Trifluralin; Triflusulfuron; Triflusulfuron-methyl; Vernolate: YRC 2388.

When present the one or more herbicides, may be included in any effective amount, and advantageously are present in amounts of from 5 ppm to 50,000 ppm, preferably 10 ppm to 10,000 ppm based on total weight of the plant treatment composition of which it forms a part, particularly in final end-use concentrations of the plant treatment compositions as applied to the plant.

The composition of the invention may further contain one or more non-biologically active materials which include, but are not limited to one or more of a surfactant, a solvent, a safener, a binder, a stabilizer, a dye, a fragrance material, a synergist, a phytotoxicity reducer, and a lubricant according to the requirements.

Non-limiting examples of surfactants useful in the plant treatment compositions of the invention include one or more of anionic, nonionic, cationic, amphoteric and zwitterionic surfactants, which can be used singly or in mixtures. Exemplary nonionic surfactants include polyoxyethylene alkyl ethers, polyoxyethylene alkyl allyl ethers, polyoxyethylene lanolin alcohols, polyoxyethylene alkyl phenol formalin condensates, polyoxyethylene sorbitan fatty acid esters, polyoxyethylene glycerol mono-fatty acid esters, polyoxypropylene glycol mono-fatty acid esters, polyoxyethylene sorbitol fatty acid esters, polyoxyethylene-castor oil derivatives, polyoxyethylene fatty acid esters, fatty acid glycerol esters, sorbitan fatty acid esters, sucrose fatty acid esters, polyoxyethylene polyoxypropylene block polymers, polyoxyethylene fatty acid amides, alkylol amides, and polyoxyethylene alkyl amines; aminonic surfactants include sodium salts of fatty acids such as sodium palmitate, ether sodium carboxylates such as polyoxyethylene lauryl ether sodium carboxylate, amino acid condensates of fatty acids such as lauroyl sodium sarcosine and N-lauroyl sodium glutamate, alkylarylsulfonates such as sodium dodecylbenzenesulfonate and diisopropylnaphthalenesulfonates, fatty acid ester sulfonates such as lauric acid ester sulfonates, dialkyl sulfosuccinates such as dioctyl sulfosuccinate, fatty acid amidosulfonates such as oleic acid amidosulfonate, formalin condensates of alkylarylsulfonates, alcohol sulfates such as pentadecane-2-sulfate, polyoxyethylene alkyl ether sulfates such as polyoxyethylene dodecyl ether sodium sulfate, polyoxyethylene alkyl phosphates such as dipolyoxyethylene dodecyl ether phosphates, styrene-maleic acid copolymers, and alkyl vinyl ether-maleic acid copolymers; and amphoteric surfactants such as N-laurylalanine, N,N,N-trimethylaminopropionic acid, N,N,N-trihydroxye thylaminopropionic acid, N-hexyl N,N-dimethylaminoacetic acid, 1-(2-carboxyethyl)-pyridiniumbetaine, and lecithin; exemplary cationic surfactants include alkylamine hydrochlorides such as dodecylamine hydrochloride, benzethonium chloride, alkyltrimethylammoniums such as dodecyltrimethylammonium, alkyldimethylbenzylammoniums, alkylpyridiniums, alkylisoquinoliniums, dialkylmorpholiniums, and polyalkylvinylpyridiniums.

Non-limiting examples of solvents useful in the plant treatment compositions of the invention include one or more of saturated aliphatic hydrocarbons such as: decane, tridecane, tetradecane, hexadecane, and octadecane; unsaturated aliphatic hydrocarbons such as 1-undecene and 1-henicosene; halogenated hydrocarbons; ketones such as acetone and methyl ethyl ketone; alcohols such as methanol, ethanol, butanol, and octanol; esters such as ethyl acetate, dimethyl phthalate, methyl laurate, ethyl palmitate, octyl acetate, dioctyl succinate, and didecyl adipate; aromatic hydrocarbons such as xylene, ethylbenzene, octadecylbenzene, dodecylnaphthalene, tridecylnaphthalene; glycols, glycol esters, and glycol ethers such as ethylene glycol, diethylene glycol, propylene glycol monomethyl ether, and ethyl cellosolve; glycerol derivatives such as glycerol and glycerol fatty acid ester; fatty acids such as oleic acid, capric acid, and enanthic acid; polyglycols such as tetraethylene glycol, polyethylene glycol, and polypropylene glycol; amides such as N,N-dimethylformamide and diethylformamide: animal and vegetable oils such as olive oil, soybean oil, colza oil, castor oil, linseed oil, cottonseed oil, palm oil, avocado oil, and shark oil; as well as mineral oils. Water and blends of water with one or more of the foregoing organic solvents are also expressly contemplated as being useful solvent constituents.

Non-limiting examples of stabilizers which may be used in the invention are one or more of antioxidants, light stabilizers, ultraviolet stabilizers, radical scabengers, and peroxide decomposers. Examples of the antioxidant are antioxidants of phenol type, amine type, phosphorus type, and sulfur type antioxidants. Examples of the ultraviolet stabilizer are that of benzotriazole type, cyanoacrylate type, salicylic acid type, and hindered amine type. Isopropyl acid phosphate, liquid paraffin, and epoxidized vegetable oils like epoxidized soybean oil, linseed oil, and colza oil may also be used as the stabilizer.

Each of the foregoing non-biologically active materials which may be individually included in effective amounts. The total amounts of the one or more non-biologically active materials may be as little as 0.001% wt., to as much as 99.999% wt., based on the total weight of the plant treatment composition of which said non-biologically active materials form a part, particularly in final end-use concentrations of the plant treatment compositions as applied to the plant.

Preferred biologically and non-biologically active materials which are preferred are those which are based on metal salts, which metals which may be complexed or bound to the alginates, as it is believed that such would from complexes which are potentially better retained.

The plant treatment compositions can be advantageously applied against a broad range of diseases in different crops. They may be applied as leaf, stem, root, into-water, seed dressing, nursery box or soil treatment compositions. Thus the plant treatment compositions of the invention can be applied to the seed, soil, pre-emergence, as well as post-emergence such as directly onto immature or mature plants. The plant treatment compositions of the invention can be applied according to conventional application techniques known to the art, including electrodynamic spraying techniques. It is hypothesized that at least the metal alginate salts are deposited and are retained on the plant matter surfaces after the carrier, viz., aqueous medium or aqueous organic solvent medium has evaporated.

The plant treatment compositions are believed to have broad applicability to pathogentic fungi and bacteria and other diseases in said plants and particularly food crops.

The plant treatment compositions are believed to have particular activity against pathogentic fungi, bacteria or other diseases in plants which are characterized to be resistant to copper or other metals, especially copper.

Citrus crop diseases which may be treated by the plant treatment compositions of the invention include: algal spot, melanose, scab, greasy spot, pink pitting, alternaria brown spot, phytophthora brown rot, sptoria spot, phytophthora foot rot, and citrus canker.

Field crop diseases which are treatable by the plant treatment compositions of the invention include: for alfalfa, cercospora leaf spot, leptosphaerulina leaf spot; for corn, bacteria stalk rot; for peanut, cercospora leaf spot; for potato and other tubers, early blight, late blight; for sugar beet, cercospora leaf spot, and for wheat, barley and oats, helminthosporium spot blotch, septoria leaf blotch.

Diseases of small fruits which are treatable by the plant treatment compositions of the invention include: for blackberry (including Aurora, Boysen, Cascade, Chehalem, Logan, Marion, Santiam, and Thornless Evergreen varietals), anthracnose, cane spot, leaf spot, pseudomonas blight, purple blotch, yellow rust; for blueberry, bacterial canker, fruit rot, phomopsis twig blight; for cranberry, fruit rot, rose bloom, bacterial stem canker, leaf blight, red leaf spot, stem blight, tip blight (monilinia); for currants and gooseberry, anthracnose, leaf Spot; for raspberry, anthracnose, cane spot, leaf spot, pseudomonas, blight, purple blotch, yellow rust; for strawberry, angular leaf spot (xanthomonas), leaf blight, leaf scorch, leaf spot.

Diseases of tree crops which are treatable by the plant treatment compositions of the invention include: in almond, apricot, cherry, plum, and prune trees and crops, bacterial blast (Pseudomonas), bacterial canker, coryneum blight (shot hole), blossom brown rot, black knot, cherry leaf spot; in apple trees and crops; anthracnose, blossom blast, european canker (nectria), shoot blast (Pseudomonas), apple scab, fire blight, collar root, crown rot; in avocado trees and crops, anthracnose, blotch, scab; in banana trees and crops, sigatoka (black and yellow types), black pitting; in cacao trees and crops, blak pod, in coffee plants and crops, coffee berry disease (Collectotrichum coffeanum), bacterial blight (Pseudomonas syringae), leaf rust (Hemileia vastatrix), iron spot (Cercospora coffeicola), pink disease (Corticium salmonicolor); in filbert trees and crops, bacterial blight, eastern filbert blight, in mango trees and crops, anthracnose, in olive trees and crops, olive knot, peacock spot; in peach and nectarine trees and crops, bacterial blast (Pseudomonas), bacterial canker, bacterial spot (Xanthomonas), coryneum blight (shot dole), leaf curl, bacterial spot; in pear trees and crops, fire blight and blossom blast (Pseudomonas); in pecan trees and crops, kernel rot, shuck rot, (Phytophthora cactorum), zonate leaf spot (Cristulariella pyramidalis), ball moss, Spanish moss; in pistachio trees and crops, botryosphaeria panicle and shoot blight, botrytis blight, late blight (Alternaria alternate), septoria leaf blight; in quince trees and crops, fire blight, and in walnut trees and crops, walnut blight.

Diseases of small fruits which are treatable by the plant treatment compositions of the invention include: in green beans, brown spot, common blight, halo blight, in beets including table beets and beet greens, cercospora leaf spot; in carrots, alternaria leaf spot, cercospora leaf spot; in celery, celeriac, bacterial blight, cercospora early blight, septoria late blight; in crucifers such as broccoli, brussels sprout, cabbage, cauliflower, collard greens, mustard greens, and turnip greens, black leaf spot (Alternaria), black rot (Xanthomonas), downy mildew; in cucurbits such as cantaloupe, cucumber, honeydew, muskmelon, pumpkin, squash, watermelon, alternaria leaf spot, angular leaf spot, anthracnose, downy mildew, gummy stem blight, powdery mildew, watermelon bacterial fruit blotch; in eggplant, alternaria blight, anthracnose, phomopsis; in okra, anthracnose, bacterial leaf spot, leaf spots, pod spot, powdery mildew; in onions and garlic, bacterial blight, downy mildew, purple blotch; in peas, powdery mildew; in peppers, anthracnose, bacterial spot, cercospora leaf spot; in spinach, anthracnose, blue mold, cercospora leaf spot, white rust, in tomato, anthracnose, bacterial speck, bacterial spot, early blight, gray leaf mold, late blight, septoria leaf spot, and in watercress, cercospora, leaf spot.

Diseases of vines and fruits which are treatable by the plant treatment compositions of the invention include: in grapes, black rot, downy mildew, phomopsis, powdery mildew; in hops, downy mildew; in kiwi, Erwinia herbicola, Pseudomonas fluorescens, Pseudomonas syringae

The following further crops and diseases which are treatable by the plant treatment compositions of the invention include: in atemoya, anthracnose; in carambola, anthracnose; in chives, downy mildew; in dill, phoma leaf spot, rhizoctonia foliage blight; in ginseng, alternaria leaf dlight, stem blight; in guava, anthracnose, red algae; in macadamia, anthracnose, phytophthora blight (P. capsici), raceme blight (Botrytis cinerea); in papaya, anthracnose; in parsley, bacterial blight (Pseudomonas sp.); in passion fruit, anthracnose; in sugar apple (Annona), Anthracnose.

Specific diseases of greenhouse and shadehouse crops which are treatable by the plant treatment compositions of the invention include: in non-bearing citrus plants, brown rot, citrus canker, greasy spot, melanose, pink pitting, scab; in cucumbers, angular leaf spot, downy mildew; in eggplant, alternaria blight, anthracnose; in tomato, anthracnose, bacterial speck, bacterial spot, early blight, gray leaf mold, late blight, septoria leaf spot.

The plant treatment compositions may be provided in a variety of product forms. In one such form a concentrated composition containing the metal alginate salts are provided in a form wherein the concentrated composition is intended to be blended were dispersed in a further fluid such as water, either without further biologically active materials or conjointly with one or more further biologically active materials, e.g., materials which exhibit or provide pesticidal, disease control, including fungicidal, mildew control or herbicidal or plant growth regulating effects, as well as any other further desired biologically inactive constituents which are recognized as being a useful in the art. In a further product form, the plant treatment compositions of the invention are provided as a ready to use product wherein the metal alginate salts are produced in situ at a concentration which requires no further dilution but can be directly applied to plants, or crops. In a still further product form, the metal alginate salts are provided in conjunction with one or more further biologically active materials, e.g., materials which exhibit or provide pesticidal, disease control, including fungicidal, mildew control or herbicidal or plant growth regulating effects, as well as any other further desired biologically inactive constituents, in the form of a premix, or in the form of a concentrate which is intended to be added to a further the carrier medium, such as an aqueous liquid which may, or may not include further constituents already present therein.

The plant treatment composition may also be provided in a powdered or solid form, e.g., a comminuted solid which can be dispersed into a fluid carrier or medium, in a concentrated form, which may be a solid, liquid, or a gel which is intended to be further dissolved or disperses in a carrier medium, such as a liquid which may be pressurized or non-pressurized, e.g., water. Such a plant treatment composition is advantageously and conveniently provided as a dispersible or dilutable concentrate composition which is then used in a “tank mix” which may optionally include further compositions or compounds, including but not limited to biologically active materials and non-biologically active materials.

The plant treatment compositions of the invention may also be provided in any suitable or conventional packaging means. For example, conventional containers such as bottles, or sachets containing a solid, liquid or fluid composition enclosed within a water-soluble film may be conveniently provided particularly when the former are provided in premeasured unit dosage forms. The latter are particularly useful in avoiding the need for measuring or packaging and provides a convenient means whereby specific doses that the plant treatment compositions can be provided.

The following examples further illustrate the present invention. It should be understood, however, that the invention is not limited solely to the particular examples given below.

### EXAMPLES

A plant treatment composition according to the present invention was produced by combining 75.6 ml of an aqueous copper sulfate (CuSO₄.5H₂O) solution comprising 1% wt. copper sulfate dissolved in water (approx. 20° C.), under mixing with 2000 ml of an aqueous sodium alginate solution comprising 0.1% wt. of a sodium alginate having an average molecular weight of 5,000-1,000,000 under constant stirring at room temperature and at normal ambient atmospheric pressure in an open beaker. Stirring was provided by a magnetic driven stirrer at a rotational speed of sufficient to create a vortex, and continued for 5 minutes following the addition of the aqueous copper sulfate solution to the sodium alginate solution. Thereafter stifling stopped, and the resultant aqueous solution was determined to contain 0.0093% wt. of copper alginate (equivalent to 93 ppm), and 0.02% wt. of sodium sulfate. The plant treatment composition was identified as “Example 1” (hereafter “E1”) and was used without further modification.

The actual concentration of the sodium alginate and the copper sulfate can be different than those given above, and may be any which is found to be effective in order to provide a metal salt alginate as an end product. These amounts can be determined by routine experimental methods. It is expressly contemplated that the compositions may be varied, e.g, the use of alginates having lesser or greater molecular weights; the use of alginates of two or more different types or molecular weights; the use of other metal salts other than copper, as well the use of a plurality of different metal salts, and yet fall within the teaching of the present invention.

Several further comparative compositions were used and their performance was compared to the E1 composition. Specifically a first comparative composition “C1” was an aqueous composition comprising 0.1% wt./wt. of metallic copper (equivalent to 1000 ppm) having a particle size of 20 nanometers, a second comparative composition “C2” was an aqueous composition comprising 0.1% wt./wt. of metallic silver (equivalent to 1000 ppm) having a particle size of 20 nanometers, a third comparative composition “C3” was an aqueous composition comprising 0.3% wt./wt. of metallic silver (equivalent to 3000 ppm) having a particle size of less than 100 nanometers, and a fourth comparative composition “C4” was an aqueous composition based on a commercially available product, KOCIDE 2000 (ex. E.I. DuPont de Nemours Co) described by its supplier to comprise 46.1% wt. of copper hydroxide providing an equivalent of 30% wt. of metallic copper, which C4 composition provided 30% wt. of metallic copper in the composition. A final set of control plants which were inoculated but which went untreated by any treatment composition are identified as “C5”.

The foregoing compositions were tested on five week old “Bonny Best” tomato plants under controlled laboratory (greenhouse) conditions. Each of the test plants was treated with one of the aqueous suspensions of the various alginate materials described above, except for the untreated control plants “C5”. The treatment compositions were applied on each plant by use of a Devilbliss sprayer, the plants were allowed to completely air dry, then a second Devilbliss sprayer was used to inoculate the plant with a stock solution of a pathogen, delivered as an inoculum which consisted of a bacterial suspension of two tomato race 4 strains from 24 hour cultures suspended in sterile tap water and adjusted to A₆₀₀=0.3 which is approximately 5×10⁸ CFU/ml. These plants were approximately 10 to 12 inches tall, spraying was until they were ‘spray to wet’ but just prior to runoff of the product. Four (4) replicate plants were treated for each composition, After being sprayed with the inoculum, the plants were placed in clean plastic bags, then put into a growth-room that was adjusted to 28° C. with a 12 hour light 12 hour dark cycle. where they were retained for 48 hours, after which the bags were removed. The bag were used in order to provide ideal conditions for bacterial inoculum growth. The plastic bags were be removed and then the plants returned to the greenhouse for the remainder of the experiment, where they were periodically watered. After 14 days from inoculation, the plants were evaluated for disease intensity by estimating percent of leaf area affected by bacterial spot using the Horsfall-Barratt scale., and the reported results were statistically analyzed.

The results of the test are reported on the following Table 1.

TABLE 1

| Treatment | Application Rate of Treatment | Observed Disease |
|---|---|---|
| Composition | Composition onto Plant | Rating |
| E1 | 90 ppm | 3.5 |
| C1 | 25 ppm | 5.0 |
| C1 | 100 ppm | 5.0 |
| C1 | 200 ppm | 4.0 |
| C2 | 5 ppm | 4.5 |
| C2 | 10 ppm | 4.0 |
| C2 | 20 ppm | 4.0 |
| C3 | 5 ppm | 5.0 |
| C3 | 10 ppm | 4.0 |
| C3 | 20 ppm | 6.0 |
| C4 (supplied as | 1655 ppm | 7.0 |
| KOCIDE) | | |
| untreated control | — | 7.0 |
| plants | | |

“Observed Disease Rating” reported on Table 1 were based on the Horsfall Barrett scales in which:
1 = 0% defoliation,
2 = 0-3% defoliation,
3 = 3-6% defoliation,
4 = 6-12% defoliation,
5 = 12-25% defoliation,
6 = 25-50% defoliation,
7 = 50-75% defoliation,
with a maximum scaled value 12 = 100% defoliation.

While the foregoing illustrates one specific formulation of a plant treatment composition, it is nonetheless to be understood that the compositions of the invention may include metallic alginate salts based on metals other than copper.

As can be seen from the foregoing, the C4 compositions (based on KOCIDE) demonstrated no apparent efficacy in controlling the plant pathogens. The compositions of compositions according to C1, C2 and C3 based on metals performed worse than the composition of the invention E1 based on metal alginate salts.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. Plant treatment compositions adapted for the treatment of food crops, comprising one or more metal alginate salts and/or metal salts of alginic acid and/or partially substituted metal salts of alginic acid with the proviso that the plant treatment compositions exclude one or more amine compounds selected from: ammonia, primary amines, secondary amines or tertiary amines, as well as salts thereof.

2. Plant treatment composition of claim 1 wherein the metal salt comprises at least one metal from the elements selected from magnesium, calcium, barium, aluminum, manganese, iron, cobalt, nickel, copper, zinc, lead, silver, gold, cadmium, tin, palladium, platinum, gold and mixtures thereof.

3. Plant treatment composition of claim 2 wherein the metal salt preferably comprises copper salts of alginic acid.

4. Plant treatment composition of claim 2 wherein the metal salt preferably comprises silver salts of alginic acid.

5. Plant treatment composition of claim 3 wherein the copper metal salt comprises copper(II) salts of alginic acid.

5. Plant treatment composition of claim 3 wherein the copper metal salt comprises copper(I) salts of alginic acid.

6. Plant treatment composition of claim 4 wherein the silver metal salt comprises silver(I) salts of alginic acid.

8.-29. (canceled)

30. Plant treatment composition of claim 4 wherein the silver metal salt comprises silver(II) salts of alginic acid.

31. Plant treatment composition of claim 2 wherein the metal salts comprise a copper metal salt and at least one secondary metal salt at least selected from sodium, potassium, magnesium, calcium, barium, aluminum, manganese, iron, cobalt, nickel, copper, zinc, lead, silver, gold, cadmium, tin, palladium, platinum, gold and mixtures thereof.

32. Plant treatment composition of claim 2 wherein the metal salts comprise a silver metal salt and at least one secondary metal salt at least selected from sodium, potassium, magnesium, calcium, barium, aluminum, manganese, iron, cobalt, nickel, copper, zinc, lead, silver, gold, cadmium, tin, palladium, platinum, gold and mixtures thereof.

33. Plant treatment composition of claim 31 wherein the metal salts comprise copper(II) and calcium(II) salts, or copper(II) and zinc(II) salts, or copper(II) and silver(I) salts, or copper(II) and copper(I) salts, or copper(II) and sodium(I) salts, or copper(II) and sodium(I) and calcium(II) salts.

34. Plant treatment composition of claim 31 wherein the metal salts comprise silver(I) and calcium(II) salts, or silver(I) and zinc(II) salts, or silver(II) and silver(I) salts, or silver(I) and aluminum(III) salts, or silver(I) and sodium(I) and calcium (II)salts

36. Plant treatment composition of claim 1 wherein no sodium salts are present.

37. Plant treatment composition of claim 1 wherein the formulation further comprises sodium and/or potassium salts.

38. Plant treatment composition of claim 1 wherein the formulation has a pH between 2 and 10.

39. Plant treatment compositions according to claim 1, wherein the said compositions exclude other biologically active materials which exhibit or provide pesticidal, disease control, including fungicidal, mildew control or herbicidal or plant growth regulating effects.

40. Plant treatment compositions according to claim 1 which include a metal alginate salt and/or metal salt of an alginic acid, wherein the metal alginate salts are copper salts or silver salts, and wherein the composition includes a sufficient amount of copper alginate salts which ultimately provides between 0.5 ppm and 50,000 ppm of metallic copper in the form of Cu(I) and/or Cu(II) ions as applied to a plant or plant part, and a largely aqueous liquid carrier, with the proviso that the plant treatment compositions exclude amine compounds selected from: ammonia, primary amines, secondary amines tertiary amines, as well as salts of said amine compounds.

41. Plant treatment compositions according to claim 1 which include a metal alginate salt and/or metal salt of an alginic acid, wherein the metal alginate salts are copper salts or silver salts, and wherein the composition includes a sufficient amount of copper alginate salts which ultimately provides between 0.5 ppm and 50,000 ppm of metallic copper in the form of Cu(I) and/or Cu(II) ions as applied to a plant or plant part, and a largely aqueous liquid carrier, with the proviso that the plant treatment compositions exclude amine compounds selected from: ammonia, primary amines, secondary amines tertiary amines, as well as salts of said amine compounds, and further wherein the plant treatment compositions also exclude biologically active materials which exhibit or provide pesticidal, disease control, including fungicidal, mildew control or herbicidal or plant growth regulating effects.

42. A method for the treatment of food crops in order to control the incidence of and/or spread of pathogentic fungi and bacteria and other diseases in said plants and particularly food crops and providing improved plant health and/or food crop yields, which method comprises the application of a plant treatment composition according to claim 1 to a plant, plant part or crop.

43. A method according to claim 42, wherein the plant treatment compositions are used to control the incidence of bacterial spot such a may be caused by genus Xanthomonas, e.g, Xanthomonas campestris pv. vesicatoria; or bacterial speck, such as may be caused by genus Pseudomonas e.g., Pseudomonas syringae PV tomato; or citrus canker, such as may be caused by genus Xanthomonas e.g., Xanthomonas axonopodis pv. citri.

44. A method for the treatment of food crops in order to control the incidence of and/or spread of pathogentic fungi and bacteria and other diseases in said plants and particularly food crops and providing improved plant health and/or food crop yields, which method comprises the application of a plant treatment composition according to claim 41 to a plant, plant part or crop.

45. A method according to claim 44, wherein the plant treatment compositions are used to control the incidence of bacterial spot such a may be caused by genus Xanthomonas, e.g, Xanthomonas campestris pv. vesicatoria; or bacterial speck, such as may be caused by genus Pseudomonas e.g., Pseudomonas syringae PV tomato; or citrus canker, such as may be caused by genus Xanthomonas e.g., Xanthomonas axonopodis pv. citri.
